(19) United States
(12) Patent Application Publication
(10) Pub. No.: US 2020/0164292 A1
(43) Pub. Date: May 28, 2020

(54) APPARATUS AND METHOD FOR LIQUID REFLUX SUCTION-FILTER-PUMP

(71) Applicant: Cuong Manh Vu, Ho Chi Minh (VN)

(72) Inventor: Cuong Manh Vu, Ho Chi Minh (VN)

(21) Appl. No.: 16/632,640

(22) PCT Filed: Jul. 12, 2018
(86) PCT No.: PCT/IB2018/055164

§ 371 Date: Jan. 21, 2020

(30) Foreign Application Priority Data
Jul. 21, 2017 (VN) 1-2017-02793

(51) Int. Cl. B01D 35/26; B01D 27/02; C02F 1/00

(52) U.S. Cl. CPC B01D 35/26; B01D 27/02; C02F 1/001; B01D 2201/202; B01D 2101/04; B01D 2221/06; B01D 2221/10; B01D 2101/02

(57) ABSTRACT

The present invention relates to an apparatus and method for liquid reflux suction-filter-pump in treating the types of waste liquid into potable water, which comprises a lower liquid chamber (10) located beneath an upper liquid chamber (20), a transmission shaft (70) connected to a dual impeller (30) in the chamber (10) to suction liquid from the chamber (10) or from the outside through a waste liquid suction hose (50) to pump into the chamber (20) or pump through a filter cartridge tube (40), and a residual tank (60) to contain residues blocked from the filter cartridge tube (40). The characteristics of the above components and the methods of integrating these components into a system can better support activities in the fields of dental care, health care, and food processing, agriculture, and industry, aerospace, submarine. In addition, the present invention refers to the method for liquid reflux suction-filter-pump in treating the types of waste liquid into potable water by using this apparatus.

### TECHNICAL FIELD

The present invention relates to an apparatus and method for liquid reflux suction-filter-pump in treating the types of waste liquid into potable water and generally in conjunction with devices, machines and or other independent technical systems in the fields of dental care, health care, food processing, agriculture, industry, aerospace, submarine and so on.

### BACKGROUND ART

At present, there are no specialized tools and devices in liquid reflux suction-filter-pump used for treating types of waste liquid into potable water in the fields of dental care, health care, food processing, agriculture, industry. Some common types used for water purification in living activities are usually placed indoor, connected to the water supply system, directly connected to the plug, and of mobile type connected to the individual water tanks/pockets. However, these types of water purification are usually by single one-way filtration devices and method.

### SUMMARY OF INVENTION

The invention's purpose is to create a new type of apparatus and method that better supports activities in the fields of dental care, health care, food processing, agriculture, industry, aerospace, submarine and so on through the ability to utilize waste liquid under conditions (failure to have new clean liquid) and/or situations or spaces (failure to easily discharge waste liquid out during operation).

In order to achieve this purpose, the invention proposes the apparatus and method for liquid reflux suction-filter-pump in treating types of waste liquid into potable water.

In one embodiment disclosed herein, the invention of the apparatus for liquid reflux suction-filter-pump comprises: a first liquid chamber (below mounted) with a cover at the top, a transmission shaft, a dual impeller with a clean liquid outlet and a waste liquid outlet, a residual tank, a waste liquid suction hose, a second liquid chamber (top mounted) with a cover at the bottom, and a filter cartridge tube.

The characteristics of the first liquid chamber and the second liquid chamber can facilitate the bonding. The first liquid chamber consists of a hole at the connector to the transmission shaft, two holes on a cover connected to two liquid outlets, and an opening mouth or hole at the bottom sealed to the waste liquid suction hosehead. The second liquid tank consists of a door with a cover located at the upper corner of the top, two holes on the cover connected to two liquid outlets, and liquid drainage holes (under back pressure) positioned around the chamber wall foot.

The characteristics of the dual impeller can facilitate attaching/connecting close joint to the transmission shaft and holes on the cover of both the first and second liquid chambers. Dual impeller consists of a first impeller attached to a second impeller through the middle partition wall in which the first impeller is constructed to push clean liquid when rotating clockwise to clean liquid outlet and the second impeller is constructed to push waste liquid when rotating counterclockwise to waste liquid outlet.

The characteristics of the filter cartridge tube can facilitate attaching/connecting close joint of the waste liquid hole to waste liquid outlet. The filter cartridge tube contains the filter particles, the filter membrane stacked in layers, including at least the activated carbon, cotton wool, and fine fabric.

In other embodiments, a number of bendable small diameter suction nozzles may replace the waste liquid suction hose. Door with a cover may include additional liquid drainage hole and is located at other location on the second liquid chamber surface. Liquid drainage holes may be clean liquid feed cocks to another system or chamber. The dual impeller can be located in the middle of the two chambers or inside the second liquid chamber and arranged so that the impellers rotate horizontally perpendicularly or vertically parallel to the transmission shaft. The filter cartridge tube can be located in the middle of the two chambers or inside the first liquid chamber.

In other embodiments, there may be an additional single impeller inside the second liquid chamber and a transmission shaft that pushes the liquid out through drainage holes. Moreover, there may be an additional automatic system control programmer (including the integrated circuit, central processing chip, software, memory drive) from smart devices such as tablets, phones to control the whole operation of the apparatus for liquid reflux suction-filter-pump.

### BRIEF DESCRIPTION OF DRAWINGS

The preferred embodiments of the invention are shown in the accompanying drawings. The applications and benefits together with the operation of the invention may be better understood by reference to a detailed description taken in connection with the below illustrations, in which:

FIG. 1

illustrates a cutaway side view of the apparatus and method for liquid reflux suction-filter-pump.

### DESCRIPTION OF EMBODIMENTS

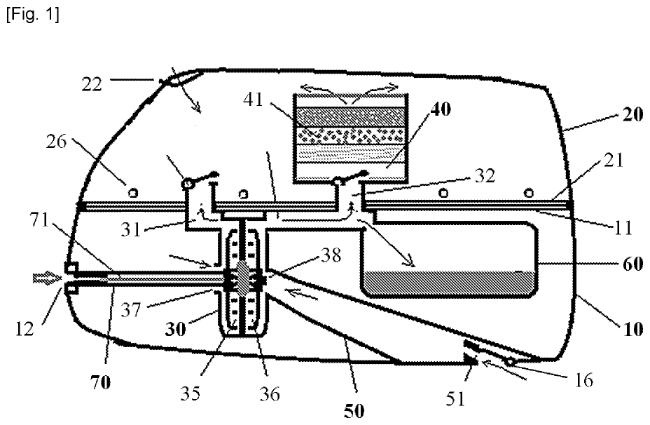

The invention according to the above figure and the brief description is described in more detail in this section. However, the invention in question may be shown and understood in other ways than limited only to the figures in this description. In which, the apparatus and method for liquid reflux suction-filter-pump can be adjusted in terms of layout, arrangement, configuration, components, elements, structure, dimensions, processes, materials, etc. to reveal and use in a specific example. Examples of the apparatus and method for liquid reflux suction-filter-pump are presented and described in detail with reference to FIG. 1.

As may best be seen in FIG. 1, the invention is a specific sample of the apparatus and method for liquid reflux suction-filter-pump includes a first liquid chamber 10, a transmission shaft 70, a dual impeller 30, a residue tank 60, a waste liquid suction hose 50, a second liquid chamber 20, and a filter cartridge tube 40.

The first liquid chamber 10 can be made of one or a combination of materials such as rubber, synthetic resin, pine resin, silicon, wood and similar materials. Chamber 10 has a cover 11 located at the top that is easily removable, designed to be sealed to prevent liquid leakage and can attach/seal to the bottom with the cover 21 of the chamber 20, axial hole 12 with a small diameter arranged in the middle of the head of the chamber to be attached to the transmission shaft head 70, with the first opening located on the cover 11 to be sealed to the outlet of one-way clean liquid valve 31 and the second opening connected to the waste liquid outlet 32 and the bottom mouth/hole 16 sealed to the outlet of one-way valve 51 of the waste liquid suction hose 50.

The second liquid chamber 20 can be made of one or a combination of materials such as rubber, synthetic resin, pine resin, silicon, wood and similar materials. Chamber 20 has a cover 21 located at the bottom that is easily removable, designed to be sealed to prevent liquid leakage and can attach/seal to the bottom with the cover 11 of the chamber 10, a door with a cover 22 located at the upper corner of the top to bring the liquid into the chamber, with the first opening located on the cover 21 to be sealed to the outlet 31 and the second opening to be sealed to the outlet 32, and liquid drainage holes 26 positioned around the chamber wall foot to push the liquid out when there is a pressure rise in the chamber.

Dual impeller 30 can be made of one or a combination of materials such as synthetic resin, silicon, wood, metal and similar materials. Dual impeller 30 has its center attached/fitted with the transmission shaft 70, consisting of a first impeller 35 attached to a second impeller 36 through the middle partition wall in which the first impeller 35 is constructed to suction clean liquid through suction mouth 37 and push to the outlet 31 when rotating clockwise and the second impeller 36 is constructed to suction waste liquid through suction mouth 38 and push to the outlet 32 when rotating counter-clockwise.

The tank 60 has an open mouth connected to the outlet 32, which is used for collecting residues and can be removable for rinsing. The suction hose 50 has an end connected to the suction mouth 38, an end to one-way valve 51 connected to the bottom mouth/hole 16 of the chamber 10.

The filter cartridge tube 40 can be made of one of the transparent materials such as synthetic resin, glass, mica or other similar materials. The filter cartridge tube has a waste liquid hole fitted with an one-way valve attaching/connecting close joint to the outlet 32 and contains the layers of inner filter material 41 including filter particles, powders, fibers, membranes and other similar materials stacked in layers, in which, includes at least the activated carbon, sand, cotton wool, fine fabric.

The transmission shaft 70 with core shaft 71 can be made of one of hard materials such as plastic, metal, porcelain, wood or other similar materials. The core shaft 71 is designed for easy two-way rotation and transmission power from the outside to the dual impeller 30.

Although various embodiments of the invention have been illustrated, however, the general and spiritual principles of the invention may be applied to other illustrative examples that are the significant difference compared to the specific embodiments presented.

The following will describe the method, operation process and effectiveness of the invention as described above.

According to the present invention, before an operation, the chamber 10 (filled with the clean liquid such as water, supplied through the clean liquid outlet 31) and the chamber 20 are sealed, stacked firmly and uniformly with the outlet 31 and outlet 32.

In operation, the clean liquid (such as water) is filled into the chamber 20 and the chamber 10 through a door with a cover 22. The core shaft 71 will be driven (rotated clockwise or counterclockwise) from an external force source through axial hole 12. When the core shaft 71 rotates clockwise, the clean liquid is suctioned through suction mouth 37 and pushed to the outlet 31. Pressure rise in the chamber 20 will push the clean liquid through the liquid drainage holes 26 arranged around the chamber wall foot. When the core shaft 71 rotates counterclockwise, the waste liquid is suctioned from the mouth/hole 16 of the chamber 10 flows through the outlet of one-way valve 51, suction hose 50 to the suction mouth 38 then pushed to the outlet 32 into the filter cartridge tube 40.

By pressure, the waste liquid will be pushed through the layers of filter material 41. The filtered liquid drains into the chamber 20. The pressure in the chamber 20 continues to increase that will push the clean liquid through the liquid drainage holes 26. Residues of the waste liquid after each filtration cycle are blocked and retained in the tank 60. Thus, the liquid flows continuously through suction-filter-pump stages to form a double loop (both suction and push from only one original liquid supply).

The advantage of this invention is the ability to utilize waste liquid under conditions (failure to have new clean liquid sources such as those used in submarines, aerospace) and/or situations or spaces (failure to easily discharge waste liquid out during operation as in dental care, surgery).

1. An apparatus for liquid reflux suction-filter-pump, comprising: a first liquid chamber; a transmission shaft; a dual impeller; a residue tank; a waste liquid suction hose; a second liquid chamber; and a filter cartridge tube.

2. The apparatus for liquid reflux suction-filter-pump of claim 1, wherein the first liquid chamber comprises a cover located at the top designed to be sealed to prevent liquid leakage; an axial hole arranged in the middle of the head of the chamber; a first opening and a second opening located on the cover; and a bottom mouth or hole.

3. The apparatus for liquid reflux suction-filter-pump of claim 1, wherein the second liquid chamber comprises a cover located at the bottom designed to be sealed to prevent liquid leakage; a door with a cover located at the upper corner of the top to bring the liquid into the chamber; a first opening and a second opening located on the cover; and liquid drainage holes positioned around the chamber wall foot.

4. The apparatus for liquid reflux suction-filter-pump of claim 1, wherein the dual impeller comprises a first impeller constructed to suction clean liquid through the suction mouth when rotating clockwise, and a second impeller constructed to suction waste liquid through the suction mouth and push to the waste liquid outlet when rotating counterclockwise.

5. The apparatus for liquid reflux suction-filter-pump of claim 1 and 4, wherein the residue tank comprises an open mouth connected to the waste liquid outlet, is designed to collect residues and can be removable for rinsing.

6. The apparatus for liquid reflux suction-filter-pump of claim 1 and 4, wherein the waste liquid suction hose comprises an end connected to the suction mouth of the second impeller; an end with the one-way valve connected to the bottom mouth or hole of the first liquid chamber.

7. The apparatus for liquid reflux suction-filter-pump of claim 1 and 3, wherein the filter cartridge tube located inside the second liquid chamber, comprising a waste liquid hole fitted with the one-way valve to attach or connect close joint to the waste liquid outlet; and inner layers of filter material filled with the stacked filter particles and membranes.

8. The apparatus for liquid reflux suction-filter-pump of claim 1 and 4, wherein the transmission shaft comprises a core shaft is designed for easy two-way rotation and transmission the force source from the outside to the dual impeller.

9. The method for liquid reflux suction-filter-pump is used for treating the types of waste liquid into potable water by using the apparatus for liquid reflux suction-filter-pump of claim 1 above, this method includes the following steps:

10. Supplying clean liquid through the clean liquid outlet into the first liquid chamber then attach the second liquid chamber to the first liquid chamber;

11. Continuing to supply clean liquid through the door with cover into the second liquid chamber and the first liquid chamber;

12. driving the core shaft to rotate clockwise with an external force source through the axial hole to rotate the first impeller to suction clean liquid through the suction mouth and push to the clean liquid outlet, then the pressure in the second liquid chamber will gradually rise and push the clean liquid through the liquid drainage holes;

13. switching to drive the core shaft to rotate counterclockwise to rotate the second impeller to suction the liquid discharged from the step above of claim 12 and/or other waste liquid through the bottom mouth or hole, through the end fitted to one-way valve, through the waste liquid suction hose into the suction mouth of the second impeller and push to the waste liquid outlet to flow into the filter cartridge tube, then the pressure in the filter cartridge tube will gradually rise and push the waste liquid through the layers of filter material into the second liquid chamber; and

14. continuing to drive the core shaft to rotate counterclockwise that makes the pressure in the second liquid chamber rise and push the clean liquid through the liquid drainage holes, and the residue of the waste liquid after each filtration cycle at the step above of claim 13 is blocked and retained in the residue tank.
